(19) United States
(12) Patent Application Publication
(10) Pub. No.: US 2023/0103496 A1
(43) Pub. Date: Apr. 6, 2023

(54) BIOLOGICAL TREATMENT APPARATUS

(71) Applicants: DDP SPECIALTY ELECTRIC MATERIALS US, LLC., Wilmington, DE (US); Specialty Electronic Materials Netherlands B.V., Dordrecht (NL)

(72) Inventors: Guillem GILABERT ORIOL, Tarragona (ES); Stephen D. JONS, Edina, MN (US); Marcus J. Slagt, Paises Bajos (NL)

(21) Appl. No.: 17/953,453

(22) Filed: Sep. 27, 2022

(30) Foreign Application Priority Data
Sep. 28, 2021 (EP) P202130908

(51) Int. Cl. B01D 61/02; B01D 24/14; B01D 61/58

(52) U.S. Cl. CPC B01D 61/025; B01D 24/14; B01D 61/58

(57) ABSTRACT

A biological treatment apparatus comprising: (a) a vessel; (b) an inlet conduit for providing feed water to an inlet region; (c) an outlet conduit for removal of treated water from an outlet region; (d) an inlet distributor comprising inlet ducts, each in fluid communication with both the inlet region and a porous surface section of the inlet duct wall; (e) an outlet distributor comprising a plurality of outlet ducts, each in fluid communication with both the outlet region and a porous surface section of the outlet duct wall; and (f) a media bed comprising particles in fluid communication with porous surface sections of both the inlet and outlet duct walls; wherein a ratio of the length of an inlet duct to a minimum distance between an inlet duct and an outlet duct is from 15:1 to 2:1.

### CROSS REFERENCE TO RELATED APPLICATIONS

This application is a U.S. Non-Provisional Application that claims the benefit of priority to European Application No. EP 202130908, which was filed on Sep. 28, 2021, and which is incorporated by reference in its entirety.

### FIELD OF THE INVENTION

It is often desired to remove impurities from water using a purification process such as hyperfiltration (reverse osmosis or nanofiltration). One common difficulty with such purification processes is biofouling, a phenomenon in which bacteria grow in the apparatus. For example, if the purification process involves passing water across a membrane, growth of a biofilm can occur on the membrane.

### BACKGROUND OF THE INVENTION

Biological treatment systems have been used for pretreatment of water prior to hyperfiltration. These systems typically remove constituents of water conducive to microbial growth such as nutrients, e.g., organic carbon, nitrate, phosphate; and oxygen, from the water to create an environment in the hyperfiltration modules that is inhospitable to microbial growth. For example, US10301206B1 discloses a biotreatment apparatus comprising particulate beds in a configuration such that water flows through the entirety of a particulate bed prior to entering a reverse osmosis unit. It is desired to provide an improved method of pretreating impure water.

### BRIEF DESCRIPTION OF THE INVENTION

The following is a statement of the invention. The present invention is directed to a biological treatment apparatus. The apparatus comprises:
(a) a vessel;
(b) an inlet conduit for providing feed water to an inlet region of the vessel;
(c) an outlet conduit for removal of treated water from an outlet region of the vessel;
(d) a plurality of inlet ducts within the vessel, each of said inlet ducts comprising an inlet duct wall that surrounds a first flow channel, said first flow channel is in fluid communication with both the inlet region and a porous surface section of the inlet duct wall;
(e) a plurality of outlet ducts within the vessel, each of said outlet ducts comprising an outlet duct wall that surrounds a second flow channel, said second flow channel is in fluid communication with both the outlet region and a porous surface section of the outlet duct wall; and
(f) a media bed located within the vessel, said media bed comprising particles a media bed located within the vessel, said media bed comprising particles in fluid communication with porous surface sections of both the inlet and outlet duct walls; wherein a ratio of a length of an inlet duct to a minimum distance between an inlet duct and an outlet duct is from 15:1 to 2:1.

### DESCRIPTION OF THE DRAWINGS

The following is a brief description of the drawings.

FIGS. 1a and 1b illustrate top and side views, respectively, of an embodiment of the present invention within a cylindrical vessel.

FIG. 2 shows an embodiment of the present invention.

FIG. 3 shows the biological treatment apparatus and downstream components.

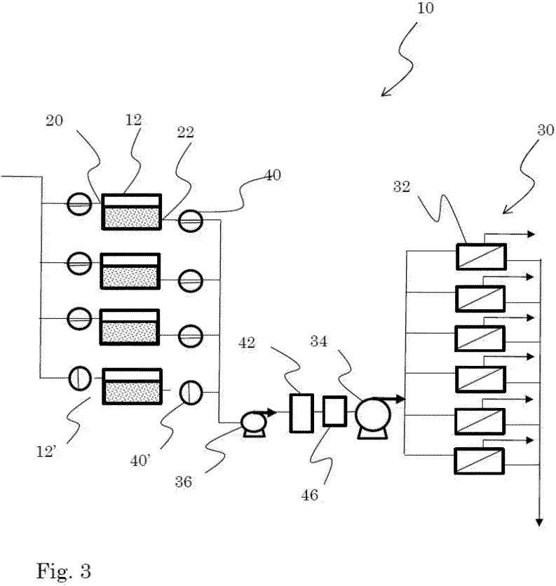

### DETAILED DESCRIPTION OF THE INVENTION AND PREFERRED EMBODIMENTS

The following is a detailed description of the invention.

As used herein, the following terms have the designated definitions, unless the context clearly indicates otherwise.

“Resin” as used herein is a synonym for “polymer.” All percentages are by weight unless otherwise specified. Vinyl monomers have a non- aromatic carbon-carbon double bond that is capable of participating in a free-radical polymerization process. Vinyl monomers include, for example, styrene, substituted styrenes, dienes, ethylene, ethylene derivatives, and mixtures thereof. Monofunctional vinyl monomers have exactly one polymerizable carbon-carbon double bond per molecule. Multifunctional vinyl monomers have two or more polymerizable carbon-carbon double bonds per molecule.

The category “acrylic monomers” is the group of monomers selected from acrylic acid; methacrylic acid; substituted or unsubstituted alkyl esters of acrylic acid or methacrylic acid; and acrylonitrile. As used herein, “vinyl aromatic monomers” are vinyl monomers that contain one or more aromatic ring.

A polymer in which at least 90% of the polymerized units (preferably at least 95%, preferably at least 99%), by weight based on the weight of the polymer, are polymerized units of one or more vinyl monomers is a vinyl polymer. A vinyl aromatic polymer is a polymer in which 50% or more of the polymerized units (preferably at least 80%, preferably at least 90%, preferably at least 95%), by weight based on the weight of the polymer, are polymerized units of one or more vinyl aromatic monomer.

A resin is considered herein to be crosslinked if the polymer includes polymerized units of multifunctional vinyl monomers, i.e., if the polymer comprises at least 1% polymerized units of multifunctional vinyl monomers. In the case of beads, the weight of the polymer is considered to be the dry weight of the bead. Resin beads may comprise typical functional groups used for ion exchange or may be unfunctionalized “adsorbent” resins.

The degree to which a particle is spherical is characterized by the sphericity Ψ, which is defined using of the three principal orthogonal axes of the object, a (longest), b (intermediate), and c (shortest), as follows: Ψ = c / a .

“Roundness” (R) is defined as the ratio of the average radius of curvature of the corners and edges of an object’s silhouette to the radius of the largest circle which can be inscribed within the silhouette. Sphericity and roundness are described in more detail in H. Waddell, The Journal of Geology, vol. 41, pp. 310-331 (1933). The minimum dimension of a particle is the smallest distance across a particle that passes through a center of mass. (e.g. This minimum dimension is equivalent to the diameter for both a spherical particle and an elongated cylinder, whereas it would be equivalent to the thickness for a thinner cylindrical “pancake”.)

Biomass can form on surfaces when impure feed waters flow through a media bed. A biofilm may form that comprises dead cells, live cell, and extracellular polymeric substances (EPS). As it continues to grow, the biofilm can increase flow resistance for fluid traveling through the media bed. At the same time, a biofilm within the media bed can deplete assimilable nutrients within the feed water.

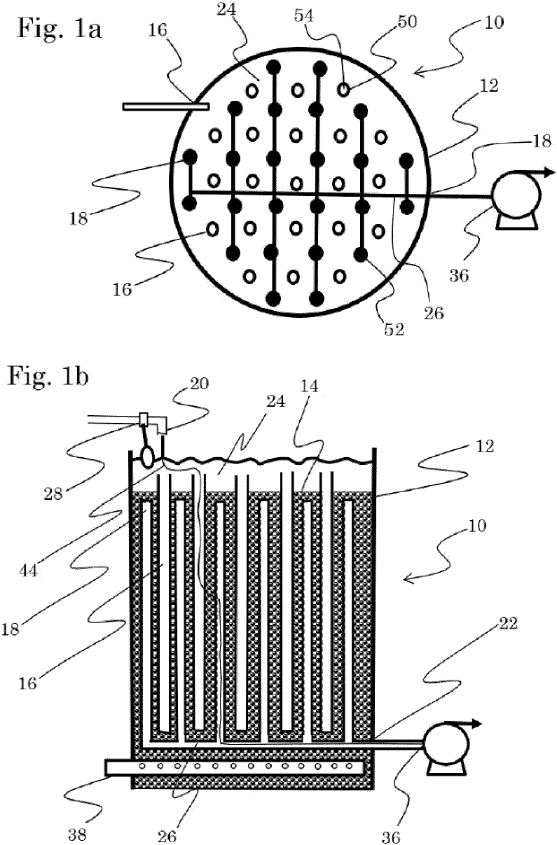

The biological treatment apparatus 10 of this invention reduces the potential for downstream biogrowth by treating impure water, referred to herein as “feed water.” One embodiment of this is illustrated in FIGS. 1a and 1b. The apparatus shown includes a vessel 12 containing a media bed 14, inlet ducts 16, and outlet ducts 18. The feed water passes through the media bed 14, traveling through the media bed 14 primarily from openings in the inlet ducts 16 to openings in the outlet ducts 18. Pressure drop and flow associated with feed water passing through the vessel 12 may be monitored.

As microorganisms grow, the resistance to flow through media bed 14 increases, resulting in a decreased flow at the same pressure difference or an increased pressure difference between the inlet and outlet conduits (20, 22) to achieve the desired flow. (The resistance to flow is roughly proportional to pressure drop across the media bed 14 and inversely proportional to measured flow. More exactly, it is defined as the pressure drop per unit distance divided by the velocity. As the measured value of resistance (R=ΔP/d/v) depends on velocity, the resistance to flow is defined for this specification for small distances at an average superficial velocity of 1 cm/sec, making it a property of media - and not the operating conditions.) It is contemplated that during normal operation of the apparatus of the present invention, formation of biomass would be monitored by measuring the pressure drop across the media, measurement of absolute pressure downstream of the biocontactor, or by measuring changes in flow rate. Other means for quantifying the biomass include measure of dissolved oxygen or phosphorous consumption by the biomass or consumption of other nutrients than phosphates, e.g., nitrogen, carbon; and measuring bio-assimilable carbon and BOD.

In preferred embodiments, the media bed 14 comprises particles with a minimum dimension greater than 0.1 mm. More preferably, the particles of minimum dimension greater than 0.1 mm have a median minimum dimension from 0.2 mm to 6 mm. Preferably, particles having greater than 0.1 mm minimum dimension have a median minimum dimension of at least media, measurement of absolute pressure downstream of the biocontactor, or by measuring changes in flow rate. Other means for quantifying the biomass include measure of dissolved oxygen or phosphorous consumption by the biomass or consumption of other nutrients than phosphates, e.g., nitrogen, carbon; and measuring bio-assimilable carbon and BOD.

In preferred embodiments, the media bed 14 comprises particles with a minimum dimension greater than 0.1 mm. More preferably, the particles of minimum dimension greater than 0.1 mm have a median minimum dimension from 0.2 mm to 6 mm. Preferably, particles having greater than 0.1 mm minimum dimension have a median minimum dimension of at least 0.95 have a median diameter according to the limits on median minimum dimension stated in this paragraph. For a particle, which is not spherical, the diameter is the diameter of a particle having the same volume.

Preferably, the media particles are made from glass, metal, or polymers. Preferably, the media particles are resin beads. Resin beads may comprise typical functional groups used for ion exchange (e.g., sulfonate, carboxylate, amino, quaternary amino) but preferably are unfunctionalized “adsorbent” resins. Preferably, the resin beads are polymerized acrylic monomers, polymerized vinyl aromatic monomers or a polymerized combination of acrylic and vinyl aromatic monomers. Preferably, the media bed 14 has a packing density of 50 to 75%, calculated as the volume of media particles divided by the total bed volume, i.e., excluding biofilm. Preferably, the height of the media bed 14 at any point does not vary more than 20% from the arithmetic average height of the bed, preferably not more than 15%.

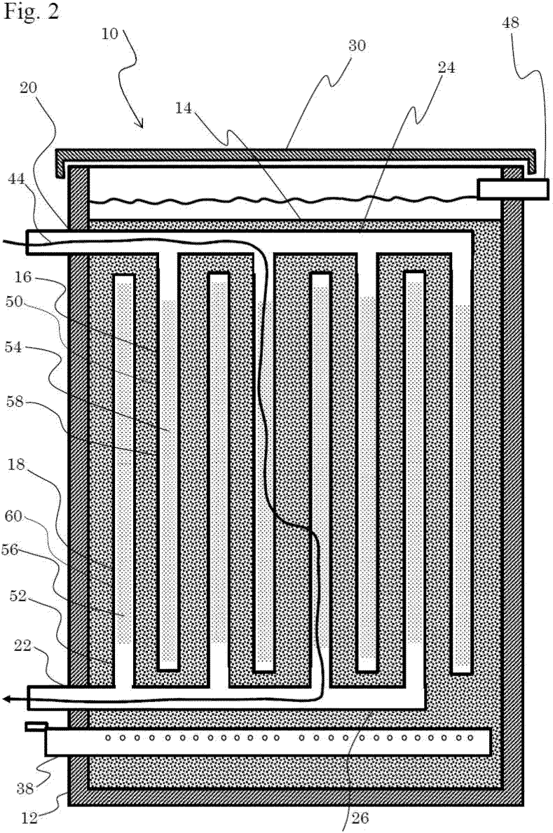

The inlet conduit 20 provides feed water to an inlet region 24. In the embodiment of FIG. 1b, the inlet conduit 20 is a spigot above the vessel 12, providing continuous or periodic flows of feed water into the vessel 12 to maintain a desired range of feed water level within the vessel 12. In a similar embodiment, the inlet conduit 20 may be immersed within the vessel 12, so that its end is not connected to the vessel 12 or components within the vessel 12. Alternatively, as illustrated in FIG. 2, the inlet conduit 20 may preferably be attached to a physical structure such as a port in the vessel 12 or a pipe with multiple holes that defines the inlet region 24. In a preferred geometry, the vessel water level is maintained above the particle bed and below the vessel wall height. The level control means 28 may include a spill way, actuating float valves, or a computer- controlled flow regulator.

The inlet conduit 20 provides feed water to an inlet region 24 that enables distribution of feed water to several inlet ducts 16 within the vessel 12. The inlet region 24 may be located inside or outside the vessel 12 or it may be partially located in each, but the inlet region 24 acts as a manifold to several inlet ducts 16. In some preferred embodiments, the inlet region 24 is created by a physical device or pipe connected to the inlet conduit 20 and having separate holes and connections suitable for attaching to individual inlet ducts 16. In other preferred embodiments, the inlet region 24 may be an open section of the vessel 12 to which a plurality of inlet ducts 16 are exposed. An example of this is illustrated in FIG. 1, where a plurality of inlet ducts 16 extend above the media bed 14, so that feed water can flow with low resistance from the inlet conduit 20 to each of the inlet ducts 16. It is important that the resistance to flow through the inlet region 24, evidenced through pressure drop for a given flow rate and path geometry, is much less than the resistance to flow through a similarly shaped section containing particles of the media bed 14. Preferably, the average resistance to flow through the inlet region 24 during operation is less than 10%, more preferably less than 5%, and even less than 1% of the resistance to flow through the media bed 14 for a similarly sized path and distance. In other embodiments, the average distance to the nearest surface within the inlet region 24 is greater than the median particle diameter within the media bed 14, more preferably at least 1 mm, and even more preferably at least 10 mm. Particles in the media bed 14 separate inlet and outlet ducts (16, 18). A plurality of flow paths between particles will exist through the media bed 14 between an inlet duct and an outlet duct.

Each of the inlet ducts 16 comprise an inlet duct wall 50 that surrounds a first flow channel 54 which is in fluid communication with both the inlet region 24 and a porous surface section 58 of the inlet duct wall 50. Similarly, each of the outlet ducts 18 comprise an outlet duct wall 52 that surrounds a second flow channel 56 which is in fluid communication with both the outlet region 26 and a porous surface section 60 of the outlet duct wall. Particles within the media bed are in fluid communication with porous surface sections (58, 60) of both inlet and outlet duct walls (50, 52). Because of the much greater resistance for flow through the media than through an inlet or outlet duct, the arrangement of multiple inlet and outlet ducts (16, 18) enable many short paths through the media bed 14. The predominant paths through the media, between an inlet duct and nearby outlet ducts 18, are preferably shorter than the lengths of either the inlet or outlet ducts 18. In preferred embodiments, the average distance between an inlet ducts 16 and its nearest outlet duct 18 is less than 50% of the average length of the inlet ducts 16. More preferably, the distance between any inlet duct and its nearest outlet duct 18 is less than 50% of the length of the inlet duct.

Preferably, the biological treatment system comprising a plurality of parallel inlet ducts 16 and a plurality of parallel outlet ducts 18. Most preferably, the inlet ducts 16 are also parallel to the outlet ducts 18. For purposes of this description, parallel inlet and outlet ducts (16, 18) are assumed to be oriented in the same direction within about 10°. In preferred embodiments, at least one set of parallel inlet ducts 16 or parallel outlet ducts 18 are oriented within 10° of vertical, so that the length of those ducts approximately corresponds to their height.

The ratio of the length of an inlet duct to a minimum distance between an inlet duct and an outlet duct 18 is from 15:1 to 2:1, preferably from 12:1 to 3:1, preferably from 10:1 to 4:1. Preferably, the inlet ducts 16 and outlet ducts 18 are substantially vertical (e.g.,within 15° of vertical, within 10° of vertical, within 5° of vertical); in which case the minimum distance between an inlet duct and an outlet duct 18 is measured horizontally. Preferably, the ratio of the number of inlet ducts 16 to the number of outlet ducts 18 is from 2:1 to 1:2, preferably 1.5:1 to 1:1.5, preferably 1.2:1 to 1:1.2. Preferably, the number of inlet ducts 16 is from 5 to 500; preferably at least 8, preferably at least 10; preferably no more than 300, preferably no more than 200, preferably no more than 100, preferably no more than 50. Preferably, the total volume of the ducts and conduits is no more than 20% of the volume of the media bed 14, preferably no more than 10%. Preferred materials of construction for ducts and conduits include metals, polymers and polymers with inorganic fillers (e.g., glass fibers (fiberglass) or mineral particles); preferably polymers and polymers with inorganic fillers. Preferred polymers include, e.g., polyethylene and polypropylene.

The shape of the ducts is not critical, but preferably, their cross-section is circular, square or rectangular. (In FIG. 1a, the ducts are drawn as cylindrical, but duct shape is not specified in FIG. 2.) In a preferred embodiment of the invention, the ducts have a narrow rectangular cross-section such that they have the appearance of plates, e.g., the thickness of the duct is no more than 25% of the next smallest dimension, preferably no more than 20%, preferably no more than 15%, preferably no more than 10%. Preferably ducts with narrow rectangular cross-section are situated such that the largest side of the duct is within 10% of vertical, preferably within 5%, i.e., the angle of the side of the duct with the top of the media bed 14 is within these percentages of 90 °. Preferably, for ducts with narrow rectangular cross-section the number of ducts is from 3 to 50; preferably at least 5, preferably at least 7; preferably no more than 40, preferably no more than 30. The ducts are porous, i.e., they have openings to allow water to pass out of the duct into the media particles (for inlet ducts 16) or to allow water to enter from the media (for outlet ducts). The size of the openings is not critical, but preferably, openings have a minimum dimension that is smaller than 99% of particles within the media bed 14, preferably smaller than 99.9% of particles within the media bed 14. In preferred embodiments, porous regions in the ducts have openings that prevent passage of 0.1 mm diameter particles.

The outlet region 26 acts as a manifold for connecting a plurality of outlet ducts 18 to the outlet conduit 22. Similar to the inlet region 24, the outlet region 26 may be located inside or outside the vessel 12 or it may be partially located in each. In some preferred embodiments, the outlet region 26 is created by a physical device or pipe connected to the outlet conduit 22 and having separate holes and connections suitable for attaching to individual outlet ducts 18. In other preferred embodiments, the outlet region 26 may be an open section of the vessel 12 to which a plurality of outlet ducts 18 are exposed, the open section being connected to the outlet conduit 22. As with the inlet region 24, it is important that the resistance to flow through the outlet region 26, evidenced through pressure drop for a given flow rate and path geometry, is much less than the resistance to flow through a similarly shaped section containing particles of the media bed 14. Preferably, the average resistance to flow through the outlet region 26 during operation is less than 10%, more preferably less than 5%, and even less than 1% of the resistance to flow through the media bed 14 for a similarly sized path and distance. In other embodiments, the (volume) averaged distance to the nearest surface within the outlet region 26 is greater than the median particle diameter within the media bed 14, more preferably at least 1 mm, and even more preferably at least 10 mm.

Preferably, the outlet conduit 22 of the biological treatment apparatus 10 is upstream of and in fluid communication with a hyperfiltration system 31 comprising at least one hyperfiltration module 32. The term “fluid communication” is defined herein as the existence of a continuously connected path from one piece of equipment to another and does not require the entire path to be filled with fluid at all times, e.g., two items separated by a pump could be in fluid communication even if part of the path through the pump was at times not filled with fluid. The biological treatment apparatus 10 will remove constituents of water conducive to microbial growth such as nutrients, e.g., organic carbon, nitrate, phosphate; and oxygen, thereby reducing growth of microorganisms on the hyperfiltration membranes. Preferably, the hyperfiltration system 31 comprises at least one pump, preferably a highpressure pump 34 between the biological treatment apparatus 10 and the hyperfiltration module(s) 32. Preferably, a highpressure pump used in this configuration is capable of providing pressurized feed to hyperfiltration modules.

Having many short treatment paths through the media enables operation with low-pressure drop. Preferably, the biological treatment apparatus 10 is configured such that flow through the apparatus is enabled by gravity alone. Preferably, the biological treatment apparatus is without the use of a pressurized feed source or a pressure vessel. Preferably, the force of gravity provides at least 80% of the outward directed force on the vessel walls. In preferred embodiments, suction from a downstream low- pressure pump 36 may provide an additional pressure difference (of less than one atmosphere) between the inlet conduit 20 and the outlet conduit 22. Preferably, the pressure difference between the inlet conduit 20 and the outlet conduit 22 is less than two atmospheres and more preferably less than one atmosphere. Preferably, the downstream low-pressure pump 36 creates at least a third of the pressure difference across the media bed 14.

A downstream pump low-pressure 36 may be used to draw flow from the outlet conduit 22 or to pressurize the flow from the outlet conduit 22 of the apparatus, but preferably no pumps are used at the inlet to force water through the inlet distributor, the media bed 14, and the outlet distributor. Preferably, the inlet conduit 20 is at a vertical position higher than the outlet conduit 22. Preferably, the inlet conduit 20 is located within or above the upper 20% of the vessel (i.e., at vertical distance from the bottom of the vessel 12 that is at least 80% of the vessel height), preferably the upper 10%. Preferably, the outlet conduit 22 is within or below the lower 10% of the vessel 12, preferably the lower 5%. Preferably, the apparatus comprises level control means to maintain the liquid level in the vessel 12 within a desired range. Preferred level control means 28 include a level sensor linked to a water intake valve and a pressure sensor measuring the pressure drop across the apparatus linked to a water intake valve.

Preferably, the path between the outlet conduit and the downstream Hyperfiltration modules 32 is sealed to prevent introduction of oxygen, which may itself be a limiting reagent in biogrowth. The vessel containing the media bed is preferably not suitable for excessive pressurization (e.g. more than 1 bar over atmosphere) and may be an open tank in some embodiments. However, the vessel may also be sealed from air. For instance, the lid shown in FIG. 2 may prevent air exchange without enabling pressurized operation. A lid 30 that extends into and below the water line may restrict the movement of air, similarly limit exchange of oxygen into the water.

Preferably, the apparatus includes a means for distributing a gas 38 through the media bed 14 to move particles in the media bed 14 about and to remove microbial growth within the media bed 14. Preferably, the gas is air, oxygen-depleted air, nitrogen or a noble gas; preferably air, oxygen-depleted air or nitrogen. Preferably, the means for distributing gas 38 comprise a distributor having multiple pipes and openings (e.g., fractal distributors or other known distributors used to distribute flow in vessels) or several ports near the bottom of the vessel for introducing the gas. In a preferred embodiment, the apparatus comprises a means for introducing chemical agents, alone or in conjunction with a gas, to remove microbial growth. Preferred chemical agents include bleach and alkali (NaOH, KOH) Preferably, means for introducing chemical agents are the same as means for distributing gas, as described above, although the means must be compatible with the agents used; this may be determined easily from chemical compatibility charts for various materials of construction.

In some preferred embodiments, the apparatus is configured to enable excess microbial growth to be removed from the surface of ducts through mechanical motion of the ducts or parts adjacent the ducts, relative to the media bed 14. For instance, ducts may be raised or rotated relative to the media bed 14, e.g., by rotating cylindrical ducts or translating rectangular ducts, either individually or together. A blade may also be used to scrape microbial growth and attached particles from the surfaces of ducts, especially in the case of ducts (plates) with narrow rectangular cross-section. Preferably, this mechanical motion relative to the media bed 14 is used to remove particles and biofilm, especially from the outer surfaces of inlet ducts 16. In preferred embodiments, the vessel 12 further comprising a waste removal conduit 48 connected to the vessel for discharge of waste.

Preferably, the apparatus further comprises a plurality of similarly configured parallel vessels 12 (with matching media bed 14, inlet and outlet ducts (16, 18), inlet and outlet regions (24, 26), and inlet and outlet conduits (20, 22) for removing bacteria and nutrients. Outlet conduits 22 from each of the plurality of parallel vessels 12 may provide treated feed water to the same hyperfiltration system 31. Isolation valves 40 allow a subset of the plurality of parallel vessels 12 to be isolated from the others for cleaning purposes. Preferably, the apparatus comprises multiple vessels 12, sufficient to allow at least one of the vessels 12' to be out of service at any given time and undergoing a cleaning process to remove excess microbial growth, with the remaining vessels 12 active and sufficient to handle the desired rate of water treatment.

In some embodiments, a particle filter 46 is arranged between the outlet conduit and said at least one hyperfiltration module.

In some preferred embodiments, the output from a plurality of parallel vessels 12 containing media for biological treatment may be sent to a downstream container enclosing a phosphate removal resin 42, e.g., resin beads containing precipitated iron oxides. This subsequent container is preferably located after vessels 12 comprising media for biological treatment and before the hyperfiltration modules 32. The container for phosphate removal resin may be pressurizable, e.g. suitable for operation above 2 bar.

The biological treatment apparatus 10 is configured to enable a plurality of flow paths 44 through the vessel 12 that, for each vessel 12, sequentially pass through each of the inlet conduit 20, the inlet region 24, an inlet ducts 16, the media bed 14, an outlet duct, the outlet region 26, and the outlet conduit 22. The multiple flow paths 44 through the vessel 12 simultaneously enable lower velocities and shorter paths to result in similar residence times for species traveling through the vessel 12, providing removal of the most assimilable materials that are prone to fouling in a downstream hyperfiltration system 31. At the same time, a larger volume of feed fluid may be treated with the same pressure drop, as compared to a passing feed fluid through the media without inlet and outlet ducts (16, 18). In a preferred embodiment, the summed cross-sectional area of all vessels 12 containing resin is less than the summed crosssectional area of all housing (pressure vessels) containing hyperfiltration modules 32 in the first stage after the biological treatment.

The present invention is further directed to a method for treating water using the biological treatment apparatus 10 described herein, preferably with one or more of the preferred limitations described herein for the apparatus. Preferably, feed water that has entered the apparatus through the inlet conduit 20 is not pressurized, and is at or within 5% of the normal atmospheric pressure where the apparatus is located. Preferably, the pressure difference between inlet and outlet conduits (20, 22) is between 0.25 bar and 2 bar, more preferably between 0.5 bar and 1.5 bar. Preferably, the average residence time in the vessel 12 is less than 1 minute, preferably from 1 second to 30 seconds; preferably at least 2 seconds, preferably at least 3 seconds; preferably no more than 20 seconds, preferably no more than 15 seconds. Preferably, the biological treatment apparatus 10 is operated at ambient temperature, preferably within 10° C. thereof, preferably within 20° C. thereof, although preferably not lower than 5° C. Preferably, excess microbial growth is removed from the biological treatment apparatus 10 when the resistance to flow (pressure difference between the inlet and outlet conduits (20, 22) divided by the flow) across the apparatus increases by at least 10% from an initial value (either at first startup or after a previous cleaning step), preferably at least 20%, preferably at least 30%. For purposes of this resistance, measurement, flow and pressure difference may be determined with 0.5 bar between inlet and outlet conduits (20, 22). For instance, if the system is operated at constant flow, resistance is proportional to the observed pressure drop across the media between the inlet and outlet conduits (20, 22). Preferably, the apparatus may be cleaned with chemicals after pressure difference between inlet and outlet conduits (20, 22) exceeds a pre-defined value.

Preferably, excess microbial growth is removed by passing a gas through the media bed 14 using a distributor or ports, as described above.

In a preferred embodiment of the method, chemical agents, as described above are added to the vessel 12 to remove excess microbial growth. Preferably, in more aggressive cleanings, the chemical agents are heated to at least 40° C., more preferably 50° C. In other embodiments, an inoculation of biological cells is provided to the biological treatment apparatus 10 subsequent to a cleaning.

1. A biological treatment apparatus comprising:
(a) a vessel;
(b) an inlet conduit for providing feed water to an inlet region of the vessel;
(c) an outlet conduit for removal of treated water from an outlet region of the vessel;
(d) a plurality of inlet ducts within the vessel, each of said inlet ducts comprising an inlet duct wall that surrounds a first flow channel, said first flow channel is in fluid communication with both the inlet region and a porous surface section of the inlet duct wall;
(e) a plurality of outlet ducts within the vessel, each of said outlet ducts comprising an outlet duct wall that surrounds a second flow channel, said second flow channel is in fluid communication with both the outlet region and a porous surface section of the outlet duct wall;
(f) a media bed located within the vessel, said media bed comprising particles in fluid communication with porous surface sections of both inlet and outlet duct walls;
wherein a ratio of a length of an inlet duct to a minimum distance between an inlet duct and an outlet duct is from 15:1 to 2:1.

2. The biological treatment apparatus of claim 1 in which said media bed comprises; particles having a minimum dimension greater than 0.1 mm and wherein said particles having a minimum dimension greater than 0.1 mm are also characterized by a median minimum dimension from 0.2 mm to 6 mm.

3. The biological treatment apparatus of claim 1 in which the outlet conduit is upstream of and in fluid communication with a hyperfiltration system comprising at least one hyperfiltration module, said hyperfiltration system comprising at least one pump between the biological treatment apparatus and said at least one hyperfiltration module, said at least one pump capable of providing pressurized feed to said at least one hyperfiltration module.

4. The biological treatment apparatus of claim 3 in which multiple pumps are located between the biological treatment apparatus and said at least one hyperfiltration module, at least one of said multiple pumps is suitable to increase flow through the media bed by inducing a greater differential pressure between the inlet and outlet conduits.

5. The biological treatment apparatus of claim 3 in which treated water between the outlet conduit and said at least one hyperfiltration module is prevented from contacting oxygen in the atmosphere.

6. The biological treatment apparatus of claim 1 in which said particles have a sphericity of at least 0.90 and a median diameter from 0.2 mm to 2 mm.

7. The biological treatment apparatus of claim 1 further comprising an air distributor suitable to supply air bubbles that mix the particles within the media bed.

8. The biological treatment apparatus of claim 1 further comprising a waste removal conduit connected to the vessel for discharge of waste.

9. The biological treatment apparatus of claim 1 further comprising a level control means for maintaining the height of liquid in the vessel within a specified range.

10. The biological treatment apparatus of claim 4, further including a particle filter between the outlet conduit and said at least one hyperfiltration module.

11. The biological treatment apparatus of claim 4, further including a resin suitable for removing phosphate located between the outlet conduit and said at least one hyperfiltration module.

12. The biological treatment apparatus of claim 4, further comprising a plurality of parallel vessels containing media, and valves suitable for isolating a least one of said plurality of parallel vessels.

13. The biological treatment apparatus of claim 4, further comprising biocontactor units operated in parallel, with one rotated out of use for occasionally cleaning.

14. The biological treatment apparatus of claim 1 in which said particles have a packing density from 50 to 75%.
